(19) United States
(12) Patent Application Publication
(10) Pub. No.: US 2025/0199108 A1
(43) Pub. Date: Jun. 19, 2025

(54) OBJECT DETECTION SYSTEM BASED ON AN ULTRA-WIDE BAND SENSOR NETWORK AND A NON-STEREO CAMERA SYSTEM

(71) Applicant: GM Global Technology Operations LLC, Detroit, MI (US)

(72) Inventors: Zijun Han, Rochester Hills, MI (US); Jinzhu Chen, Troy, MI (US); Fan Bai, Ann Arbor, MI (US)

(21) Appl. No.: 18/538,548

(22) Filed: Dec. 13, 2023

(51) Int. Cl. G01S 5/02; G06T 7/277; G06T 7/50; G06T 7/80

(52) U.S. Cl. CPC G01S 5/02585; G06T 7/277; G06T 7/50; G06T 7/80; G06T 2207/10028; G06T 2207/20084; G06T 2207/30252

(57) ABSTRACT

An object detection system for a vehicle that estimates a location of a target object located in an environment surrounding the vehicle includes an ultra-wide band (UWB) sensor network including three or more anchors mounted to the vehicle in wireless communication with a tag mounted to the target object, a non-stereo camera system that captures image data representing the target object located in the environment surrounding the vehicle, and one or more controllers in electronic communication with the UWB sensor network and the non-stereo camera system. The one or more controllers includes one or more processors that execute instructions to fuse together a camera-based location of the target object and a UWB-based location of the target object by a Bayesian filter to estimate the location of the target object.

### INTRODUCTION

The present disclosure relates to an object detection system for a vehicle that fuses together data from an ultra-wide band (UWB) sensor network and a non-stereo camera system to estimate a location of a target object located in an environment surrounding the vehicle.

An autonomous vehicle executes various tasks such as, but not limited to, perception, localization, mapping, path planning, decision making, and motion control. For example, an autonomous vehicle may include perception sensors such as a stereo camera system, LiDAR, and radar for collecting perception data regarding the environment surrounding the vehicle. The perception data collected by the stereo camera system as well as the LiDAR and radar sensors may be used for object detection and distance ranging.

It is to be appreciated that the current approach for performing object detection and distance ranging based on perception data collected by the LiDAR sensors is complex and computationally intensive and the radar sensors tend to consume relative large amounts of power. In one approach to reduce the complexity and computational requirements, the LiDAR and radar sensors may be replaced with an ultra-wide band (UWB) sensor network. However, UWB sensor networks have drawbacks as well. Specifically, UWB sensor networks only provide a limited range of detection and require the target object to be equipped with a UWB sensor. Furthermore, many vehicles are equipped with only a single or non-stereo camera system, which may not provide accurate depth estimation of the target object by itself.

Thus, while current object detection systems achieve their intended purpose, there is a need in the art for an improved approach for object detection and distance ranging based on image data captured by a non-stereo camera system.

### SUMMARY

According to several aspects, an object detection system for a vehicle that estimates a location of a target object located in an environment surrounding the vehicle is disclosed. The object detection system includes an ultra-wide band (UWB) sensor network including three or more anchors mounted to the vehicle that are in wireless communication with a tag mounted to the target object, where each anchor sends and receives sensor signals that indicate real-time distances between each anchor and the tag. The object detection system includes a non-stereo camera system that captures image data representing the target object located in the environment surrounding the vehicle and one or more controllers in electronic communication with the UWB sensor network and the non-stereo camera system. The one or more controllers include one or more processors that execute instructions to estimate a camera-based location of the target object based on the image data, where the camera-based location is adjusted to account for a calibrated camera estimated depth determined during an initial calibration procedure. The one or more controllers estimate a UWB-based location of the target object by executing one or more range-based localization algorithms that analyze the sensor signals. The one or more controllers fuse together the camera-based location of the target object and the UWB-based location of the target object by a Bayesian filter to estimate the location of the target object.

In another aspect, the Bayesian filter is a Kalman filter.

In yet another aspect, a process model of the Kalman filter predicts a plurality of state vectors of the vehicle.

In an aspect, a measurement model of the Kalman filter performs an update of the plurality of state vectors of the vehicle determined by the process model based on an observation vector.

In another aspect, the calibrated camera estimated depth represents a raw camera depth of the target object determined based on the image data captured by the non-stereo camera system that is calibrated based on a real depth of the target object.

In yet another aspect, the real depth of the target object is determined based on the sensor signals from the UWB sensor network.

In an aspect, the initial calibration procedure includes executing one or more rotated object detection algorithms that determine a rotated bounding box that identifies the target object located within a corresponding image frame of the image data.

In another aspect, the rotated object detection algorithm is the you only look once (YOLO) Darknet-53 algorithm with a recurrent neural network (RNN).

In yet another aspect, the initial calibration procedure includes determining a plurality of location parameters of the rotated bounding box, wherein the location parameters of the rotated bounding box include an x-axis location coordinate, a y-axis pixel coordinate, a width of the rotated bounding box, a height of the rotated bounding box, and an angular orientation of the rotated bounding box relative to the horizontal axis of the corresponding image frame.

In an aspect, the initial calibration procedure includes determining a raw camera depth based on:

$${d}_{cam} = \frac{{f}_{cam} * {h}_{real}}{{h}_{b}}$$

where d_{cam} represent the raw camera depth, h_{b} represents the height of the rotated bounding box h_{b}, f_{cam} represents a focal length of a camera that is part of the non-stereo camera system, and dᵣₑₐₗ represents a real depth of the target object determined based on the sensor signals received from the three or more anchors.

In another aspect, a relationship between the raw camera depth and a center of the corresponding image frame is expressed by an equation of a line:

$$y = β x + γ$$

where β represents a gradient of the line and γ represents a y-axis intercept point of the line.

In yet another aspect, the initial calibration procedure includes solving a linear regression model representing a relationship between the raw camera depth, the real depth of the target object, an error that is introduced by image distortion of the camera, the gradient, the y-axis intercept point, and a center of the corresponding image frame, and where the linear regression model is expressed as:

$$e = {d}_{cam} - {d}_{real} = β * {d}_{cen} + γ$$

where e represents the error and d_{cen} represents the center of the corresponding image frame.

In an aspect, the initial calibration procedure includes solving for the calibrated camera estimated depth based on a difference between the raw camera depth and the error that is expressed as:

$${D}_{cali} = {d}_{cam} - e$$

where D_{cali} represents the calibrated camera estimated depth.

In another aspect, the calibrated camera estimated depth accounts for an error introduced by lens distortion of a camera that is part of the non-stereo camera system, and where the error is linearly related to a center of a corresponding image frame of the image data.

In yet another aspect, the one or more processors of the one or more controllers execute instructions to build a vector map based on an attractive field force between the vehicle and a target location, repulsive field forces between the vehicle and the target object and the vehicle and one or more remaining objects located in the environment, and an overall field force at a current location of the vehicle.

In an aspect, the target location represents a destination location of the vehicle.

In another aspect, an object detection system for a vehicle that estimates a location of a target object located in an environment surrounding the vehicle is disclosed. The object detection system includes a UWB sensor network including three or more anchors mounted to the vehicle that are in wireless communication with a tag mounted to the target object, where each anchor sends and receives sensor signals that indicate real-time distances between each anchor and the tag. The object detection system includes a non-stereo camera system that includes a camera that captures image data representing the target object located in the environment surrounding the vehicle and one or more controllers in electronic communication with the UWB sensor network and the non-stereo camera system. The one or more controllers includes one or more processors that execute instructions to estimate a camera-based location of the target object based on the image data, where the camera-based location is adjusted to account for a calibrated camera estimated depth determined during an initial calibration procedure, and where the calibrated camera estimated depth accounts for an error introduced by lens distortion of the camera and the error is linearly related to a center of a corresponding image frame of the image data. The one or more controllers estimate a UWB-based location of the target object by executing one or more range-based localization algorithms that analyze the sensor signals, and fuse together the camera-based location of the target object and the UWB-based location of the target object by a Kalman filter to estimate the location of the target object.

In another aspect, the initial calibration procedure includes executing one or more rotated object detection algorithms that determine a rotated bounding box that defines the target object located within a corresponding image frame of the image data.

In yet another aspect, the rotated object detection algorithm is the you only look once (YOLO) Darknet-53 algorithm with a recurrent neural network (RNN).

In an aspect, an object detection system for a vehicle that estimates a location of a target object located in an environment surrounding the vehicle is disclosed. The object detection system includes a UWB sensor network including three or more anchors mounted to the vehicle that are in wireless communication with a tag mounted to the target object, where each anchor sends and receives sensor signals that indicate real-time distances between each anchor and the tag. The object detection system includes a non-stereo camera system that includes a camera that captures image data representing the target object located in the environment surrounding the vehicle and one or more controllers in electronic communication with the UWB sensor network and the non-stereo camera system. The one or more controllers includes one or more processors that execute instructions to estimate a camera-based location of the target object based on the image data, where the camera-based location is adjusted to account for a calibrated camera estimated depth determined during an initial calibration procedure, and where the calibrated camera estimated depth accounts for an error introduced by lens distortion of the camera and the error is linearly related to a center of a corresponding image frame of the image data, and wherein the initial calibration procedure includes executing one or more rotated object detection algorithms that determine a rotated bounding box that defines the target object located within a corresponding image frame of the image data. The controllers estimate a UWB-based location of the target object by executing one or more range-based localization algorithms that analyze the sensor signals and fuse together the camera-based location of the target object and the UWB-based location of the target object by a Kalman filter to estimate the location of the target object.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 illustrates a schematic diagram of a vehicle including the disclosed object detection system that includes an ultra-wide band (UWB) sensor network and a non-stereo camera system in electronic communication with one or more controllers, according to an exemplary embodiment;

FIG. 2 is a block diagram illustrating the software architecture of the one or more controllers shown in FIG. 1, according to an exemplary embodiment; and

FIG. 3 illustrates image data captured by the non-stereo camera system shown in FIG. 1 representing an environment surrounding the vehicle, according to an exemplary embodiment.

### DETAILED DESCRIPTION

The following description is merely exemplary in nature and is not intended to limit the present disclosure, application, or uses.

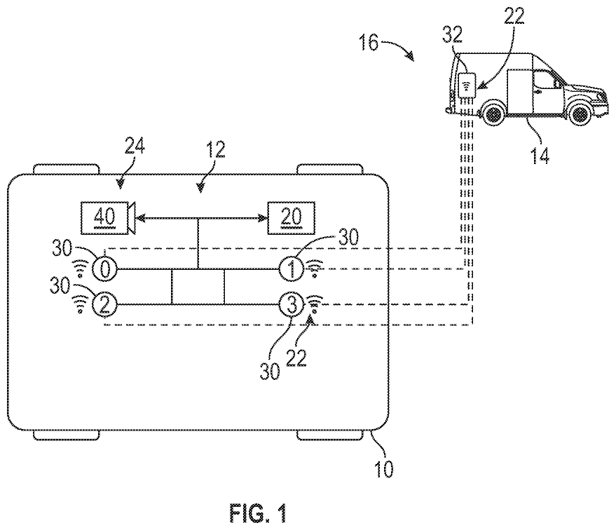

Referring to FIG. 1, a vehicle 10 including the disclosed object detection system 12 is illustrated. As explained below, the object detection system 12 estimates a location of or more target objects 14 located in an environment 16 surrounding the vehicle 10 by fusing data collected by an ultra-wide band (UWB) sensor network 22 and a non-stereo camera system 24 together. In the non-limiting embodiment as shown in the figures, the target object 14 located in the environment 16 is a secondary vehicle, and the vehicle 10 represents the ego vehicle. However, it is to be appreciated that FIG. 1 is merely exemplary in nature. Indeed, the target object 14 may be any type of stationary or moving object found in the environment 16 such as, for example, a pedestrian, a bicycle, an animal, a light pole, or a traffic sign. It is also to be appreciated that the vehicle 10 may be any type of vehicle such as, but not limited to, a sedan, a truck, sport utility vehicle, van, or motor home.

The object detection system 12 includes one or more controllers 20 in electronic communication with the UWB sensor network 22 and the non-stereo camera system 24. The non-stereo camera system 24 captures image data representing the target object 14 located in the environment 16 surrounding the vehicle 12. Although a non-stereo camera system 24 is described, it is to be appreciated that a stereo camera system may be used as well. The UWB sensor network 22 includes three or more anchors 30 in wireless communication with a tag 32. In the non-limiting embodiment as shown in FIG. 1, the UWB sensor network 22 includes four anchors 30 mounted to the vehicle 12, and the tag 32 is mounted to the target object 14.

The non-stereo camera system 24 includes a single camera 40 mounted to the vehicle 12 that captures the image data indicative of the environment 16 surrounding the vehicle 10. It is to be appreciated that although a single camera 40 is illustrated in FIG. 1, in embodiments the vehicle 10 may include more than one camera 40 as well. The anchors 30 of the UWB sensor network 22 are mounted to the vehicle 12, while the tag 32 of the UWB sensor network 22 is mounted to the target object 14 located in the environment 16 surrounding the vehicle 10. The tag 32 is a mobile sensor that is moveably remote from the vehicle 10 that sends and receives sensor signals. Each anchor 30 of the UWB sensor network 22 is in wireless communication with the tag 32 to send and receive the sensor signals for tracking a location of the tag 32. The sensor signals indicate real-time distances between each anchor 30 that is mounted to the vehicle 12 and the tag 32.

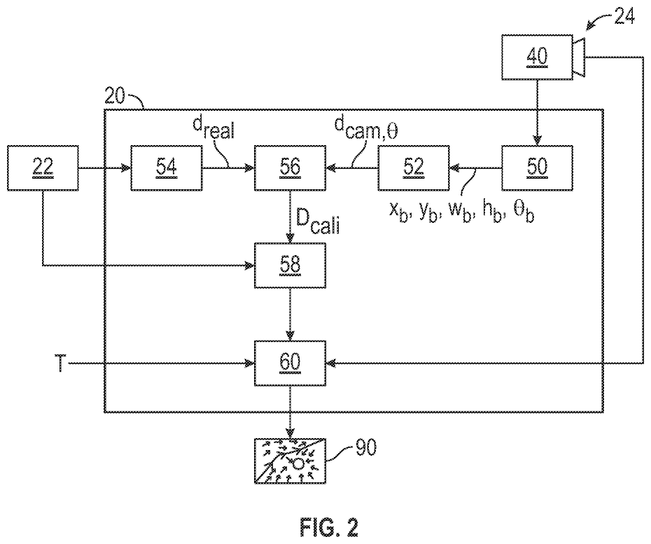

FIG. 2 is a block diagram illustrating the software architecture of the one or more controllers 20 shown in FIG. 1. The one or more controllers 20 include an object detection module 50, a depth and angle module 52, a range-based localization module 54, a calibration module 56, a sensor fusion module 58, and a path planning and navigation module 60. As explained below, the object detection module 50, the depth and angle module 52, the range-based localization module 54, and the calibration module 56 estimate a calibrated camera estimated depth D_{cali} during an initial calibration procedure that is performed offline. The calibrated camera estimated depth D_{cali} is saved in memory of the one or more controllers 20. The calibrated camera estimated depth D_{cali} represents a raw camera depth d_{cam} of the target object 14 determined based on the image data captured by the non-stereo camera system 24 that is calibrated based on a real depth dᵣₑₐₗ of the target object 14 determined based on the sensor signals from the UWB sensor network 22. It is to be appreciated that the real depth dᵣₑₐₗ of the target object 14 determined based on the sensor signals from the UWB sensor network 22 is the actual depth of the target object 14 and, and the object detection system 12 calibrates the image data captured by the non-stereo camera system 24 based on the sensor signals from the UWB sensor network 22.

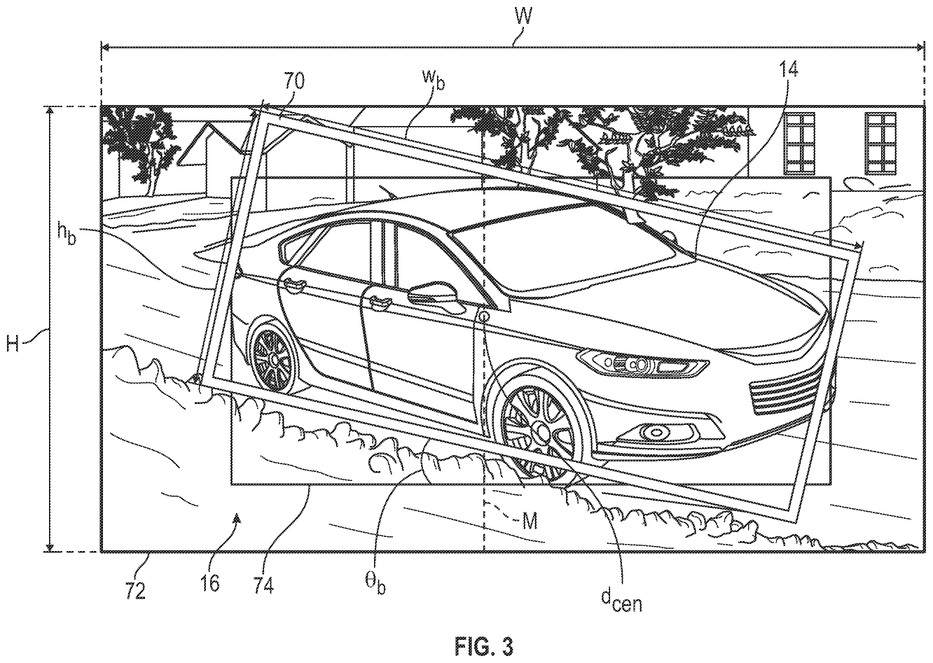

It is to be appreciated that the initial calibration procedure is executed offline and the calibrated camera estimated depth D_{cali} is saved in memory of the one or more controllers 20. The initial calibration procedure shall now be described. Referring to both FIGS. 2 and 3, the object detection module 50 of the one or more controllers 20 receives the image data captured by the non-stereo camera system 24, where the image data is indicative of the environment 16 surrounding the vehicle 12. The object detection module 50 executes one or more rotated object detection algorithms that determine a rotated bounding box 70 (shown in FIG. 3) that identifies the target object 14 located with a corresponding image frame 72 of the image data. It is to be appreciated the target object 14 includes an arbitrary orientation that is not aligned with a horizontal axis 74 of a corresponding image frame 72 (FIG. 3), and therefore requires the rotated bounding box 70. One example of a rotated object detection algorithm is the you only look once (YOLO) Darknet-53 algorithm with a recurrent neural network (RNN), however, it is to be appreciated that other types of rotated object detection algorithms may be used as well.

The object detection module 50 of the one or more controllers 20 determines a plurality of location parameters of the rotated bounding box 70, where the location parameters indicate a location of the rotated bounding box 70 relative to the image frame 72 and dimensions of the rotated bounding box 70. Specifically, in one embodiment, the location parameters of the rotated bounding box 70 include an x-axis location coordinate x_{b} (expressed in pixels), a y-axis pixel coordinate y_{b} (expressed in pixels), a width of the rotated bounding box w_{b}, a height of the rotated bounding box h_{b}, and an angular orientation of the rotated bounding box θ_{b} relative to the horizontal axis 74 of the image frame 72.

The depth and angle module 52 of the one or more controllers 20 receives the plurality of location parameters of the rotated bounding box 70 and estimates a raw camera depth d_{cam} and a raw angle θ of the target object 14 relative to the camera 40 based on the plurality of location parameters of the rotated bounding box 70, the size of the image frame 72, and the dimensions of the vehicle 12. Specifically, the size of the image frame 72 includes a width W and a height H of the image frame, and the dimensions of the vehicle 12 include a real vehicle height hᵣₑₐₗ and a real vehicle width wᵣₑₐₗ. The raw camera depth d_{cam} is determined based on Equation 1, which is as follows:

$${d}_{cam} = \frac{{f}_{cam} * {h}_{real}}{{h}_{b}} \qquad Equation 1$$

where f_{cam} represents a focal length of the camera 40, where the focal length f_{cam} is calibrated offline.

The raw angle θ of the target object 14 relative to the camera 40 is determined based on the raw camera depth d_{cam} and is expressed in Equations 2-4, which are as follows:

$${x}^{′} = \frac{W}{2} - ( {x}_{b} + \frac{{w}_{b}}{2} ) \qquad Equation 2$$

$$offset = \frac{{h}_{real} * {x}^{′}}{{h}_{b}} \qquad Equation 3$$

$$θ = arcsin ( \frac{offset}{{d}_{cam}} ) \qquad Equation 4$$

where x′ represents a distance from a vertically oriented midpoint M of the image frame 72 (FIG. 3) to a center of the rotated bounding box 70.

The range-based localization module 54 of the one or more controllers 20 receives the sensor signals from the anchors 30 of the UWB sensor network 22 that indicate the real-time distances between each anchor 30 that is mounted to the vehicle 12 and the tag 32, where the tag 32 is mounted to the target object 14. The range-based localization module 54 executes one or more range-based localization algorithms to determine a real depth dᵣₑₐₗ of the target object 14 based on the real-time distances between each anchor 30 and the tag 32 of the UWB sensor network 22 based on the sensor signals received from the anchors 30. Specifically, as explained below, any range-based triangulation localization algorithm such as, for example, the least squares error algorithm may be used to determine the real depth dᵣₑₐₗ of the target object 14.

The calibration module 56 of the one or more controllers 20 receives the raw camera depth d_{cam} and the raw angle θ of the target object 14 relative to the camera 40 from the depth and angle module 52 and the real depth dᵣₑₐₗ of the target object 14 determined by the UWB sensor network 22 from the range-based localization module 54 and determines the calibrated camera estimated depth D_{cali}. The calibrated camera estimated depth D_{cali} accounts for an error e that is introduced by lens distortion of the camera 40, where the error e is linearly related to a center d_{cen} of the image frame 72 (shown in FIG. 3).

It is to be appreciated that there is a linear relationship between the raw camera depth d_{cam} determined by the object detection module 50 and the center d_{cen} of the image frame 72 (shown in FIG. 3). Specifically, in one embodiment, the relationship between the raw camera depth d_{cam} and the center d_{cen} of the image frame 72 is expressed by an equation of a line, or y=βx+γ, where β represents a gradient of the line and γ represents a y-axis intercept point of the line. During the initial calibration procedure, the calibration module 56 of the one or more controllers 30 solves a linear regression model that represents a relationship between the raw camera depth d_{cam}, the real depth dᵣₑₐₗ, the error e, the gradient β, the intercept point γ, and the center d_{cen} of the image frame 72, and is expressed in Equation 5:

$$e = {d}_{cam} - {d}_{real} = β * {d}_{cen} + γ \qquad Equation 5$$

where the center d_{cen} of the image frame 72 is calculated based on the location parameters of the rotated bounding box 70 (shown in FIG. 3). Specifically, in one embodiment, the center d_{cen} of the image frame 72 is calculated based on the x-axis location coordinate x_{b}, the width of the rotated bounding box w_{b}, and the height of the rotated bounding box h_{b}, and is expressed in Equation 6 as:

$${d}_{cen} = \sqrt{{( {x}_{b} - \frac{{w}_{b}}{2} )}^{2} + {( {y}_{b} - \frac{{h}_{b}}{2} )}^{2}} \qquad Equation 6$$

The gradient β is based on a partial derivative of the center d_{cen} of the image frame 72 (shown in FIG. 3) and a partial derivative of the raw camera depth d_{cam} and is expressed in Equation 7 as:

$$β = \frac{{δ}_{cam}}{{δ}_{cen}} \qquad Equation 7$$

The calibration module 56 of the one or more controllers 20 solves for the intercept point γ by placing the target object 14 at the center d_{cen} of the image frame 72 and determining a difference in distance between the center d_{cen} of the image frame 72 and the raw camera depth d_{cam} and is expressed in Equation 8 as:

$$γ = {d}_{cam} - {d}_{cen} \qquad Equation 8$$

The calibration module 56 of the one or more controllers 20 solves for the calibrated camera estimated depth D_{cali} based on a difference between the raw camera depth d_{cam} and the error e and is expressed in Equation 9 as:

$${D}_{cali} = {d}_{cam} - e \qquad Equation 9$$

Referring to FIG. 2, the sensor fusion module 58 of the one or more controllers 20 receives the image data from the non-stereo camera system 24 and estimates a camera-based location Lₓ^{Cam}, L_{y}^{Cam} of the target object 14 based on the image data, where the camera-based location Lₓ^{Cam}, L_{y}^{Cam} is adjusted to account for the calibrated camera estimated depth D_{cali} that is determined by the initial calibration procedure described above. The sensor fusion module 58 of the one or more controllers 20 determines the camera-based location Lₓ^{Cam}, L_{y}^{Cam} of the target object 14 by executing one or more rotated object detection algorithms to determine the rotated bounding box 70 (shown in FIG. 3) that defines the target object 14 located in the environment 16 surrounding the vehicle 12 (FIG. 1), determining the location parameters of the rotated bounding box 70 (x_{b}, y_{b}, w_{b}, h_{b}, θ_{b}), and estimating the raw camera depth d_{cam} based on Equation 1 (shown above), where the raw camera depth d_{cam} indicates the location Lₓ^{Cam}, L_{y}^{Cam} of the target object 14. The sensor fusion module 58 then calibrates the location Lₓ^{Cam}, L_{y}^{Cam} of the target object 14 based on the calibrated camera estimated depth D_{cali} and the raw angle θ of the target object 14 based on Equation 10, which is:

$$[ {L}_{x}^{Cam} , {L}_{y}^{Cam} ] = [ sin θ * {D}_{cali} , cos θ * {D}_{cali} ] \qquad Equation 10$$

The sensor fusion module 58 of the one or more controllers 20 receives the sensor signals from the anchors 30 of the UWB sensor network 22 that indicate the real-time distances between each anchor 30 that is mounted to the vehicle 12 and the tag 32. The sensor fusion module 58 of the one or more controllers estimates a UWB-based location Lₓ^{UWB}, L_{y}^{UWB} of the target object 14 by executing one or more range-based localization algorithms that analyze the sensor signals. In one embodiment, the sensor fusion module 58 executes a range-based triangulation localization algorithm such as the least squares error algorithm to estimate the UWB-based location Lₓ^{UWB}, L_{y}^{UWB} of the target object 14, which is expressed in Equation 11 as:

$$[ {L}_{x}^{UWB} , {L}_{y}^{UWB} ] = {f}_{LSE} ( {d}_{1}^{UWB} , {d}_{2}^{UWB} , … , {d}_{n}^{UWB} , {o}_{1}^{UWB} , {o}_{2}^{UWB} , … , {o}_{n}^{UWB} ) \qquad Equation 11$$

where f_{LSE} represents the least squares error algorithm, d₁^{UWB}, d₂^{UWB}, . . . , dₙ^{UWB} represent a distance range between a respective anchor 30 and the tag 32, where the UWB sensor network 22 includes an n number of anchors 30, and o₁^{UWB}, o₂^{UWB}, . . . , oₙ^{UWB} represent mounting locations of each anchor 30 on the vehicle 12 (FIG. 1).

The sensor fusion module 58 of the one or more controllers 20 fuses together the camera-based location Lₓ^{Cam}, L_{y}^{Cam} of the target object 14 and the UWB-based location Lₓ^{UWB}, L_{y}^{UWB} of the target object 14 by a Bayesian filter to estimate the location of the target object 14 (FIG. 1). Some examples of Bayesian filters include, but are not limited to, a particle filter and a Kalman filter. In the example as described, a Kalman filter is used to estimate the location of the target object 14. It is to be appreciated that other types of filters may be used as well. For example, in another embodiment, a linear or a non-linear filter may be used instead.

In one embodiment, a process model of the Kalman filter predicts a plurality of state vectors xₖ of the vehicle 12, and a measurement model of the Kalman filter performs an update of the plurality of state vectors xₖ of the vehicle 12 determined by the process model based on an observation vector zₖ. The plurality of state vectors xₖ of the vehicle 12 include a current location Lₓ, L_{y} of the vehicle 12 expressed in x and y coordinates and a current velocity Vₓ, V_{y} of the vehicle 12 expressed in x and y coordinates at a current timestamp k.

The process model of the Kalman filter is expressed in Equation 12 as:

$${x}_{k} = {Ax}_{k - 1} + {w}_{k} \qquad Equation 12$$

where A represents a state transition matrix at time k−1, xₖ₋₁ represents the state vectors at a previous timestamp k−1, and wₖ represents a normally distributed system noise.

The measurement model of the Kalman filter is expressed in Equation 13 as:

$${z}_{k} = {Hx}_{k} + {v}_{k} \qquad Equation 13$$

where zₖ represents an observation vector at a current (kₜₕ) timestamp, H represents the observation matrix of either the camera 40 or the UWB sensor network 22, and vₖ represents observation noise, where the observation noise is Gaussian white noise. The observation matrix H of the camera 40 is expressed as

$$H = [ \begin{matrix}{L}_{x}^{Cam} , 0 , 0 , 0 \\ 0 , {L}_{y}^{Cam} , 0 , 0\end{matrix} ]$$

and the observation matrix H of the UWB sensor network 22 is expressed as

$$H = [ \begin{matrix}{L}_{x}^{UWB} , 0 , 0 , 0 \\ 0 , {L}_{y}^{UWB} , 0 , 0\end{matrix} ] .$$

The sensor fusion module 58 of the one or more controllers 20 then estimates the location of the target object 14 based on the the plurality of state vectors xₖ of the vehicle 12 at the previous timestamp and the observation vector zₖ at the current timestamp based on Equation 14, which is:

$${x}_{k} = {Ax}_{k - 1} + {z}_{k} + {w}_{k} \qquad Equation 14$$

Referring to FIG. 2, the path planning and navigation module 60 of the one or more controllers 20 receive a target location T of the vehicle 12, where the target location T represents a destination location of the vehicle 12. For example, in one non-limiting embodiment, the target location is a parking spot. The path planning and navigation module 60 builds a vector map 90 based on field forces from the target object 14, remaining objects located in environment 16 surrounding the vehicle 12, and the target location T. Specifically, the vector map 90 is built based on an attractive field force from the target location T, repulsive field forces from the target object 14 as well as the remaining objects located in the environment 16, and an overall field force from a current location of the vehicle 12. It is to be appreciated that the current location of the vehicle 12 is constantly changing as the vehicle 12 travels, and therefore the current location of the vehicle 12 may be represented by any pixel that is part of the vector map 90. The attractive field force at the target location T is expressed in Equation 15 and an angle of the attractive field force is expressed in Equation 16 as:

$${P}_{A} = c \sqrt{{\vert x - {x}_{g} \vert}^{2} + {\vert y - {y}_{g} \vert}^{2}} \qquad Equation 15$$

$${θ}_{A} = {tan}^{- 1} ( \frac{{y}_{g} - y}{{x}_{g} - x} ) \qquad Equation 16$$

where P_{A} represents the attractive field force, (x_{g}, y_{g}) represents the coordinates of the target location T, c represents a constant, θ_{A} represents the angle of the attractive field force, and x, y represent the x and y coordinates of the target location T. The repulsive field forces of the target object 14 as well as the remaining target objects located in the environment 16 are determined by calculating a distance between the vehicle 12 and a corresponding object, and is expressed in Equation 17 as:

$$d = \sqrt{{\vert x - {x}_{k} \vert}^{2} + {\vert y - {y}_{k} \vert}^{2}} \qquad Equation 17$$

where d represents the distance between the vehicle 12 and a kₜₕ object and xₖ, yₖ represent the x and y coordinates of the kₜₕ object.

The path planning and navigation module 60 then categorizes each object by class, where the class of object indicates a specific type of object. Some examples of the specific type of object include, but are not limited to, a human being, a passenger vehicle, a commercial truck, a commercial bus, an animal such as a dog or a cat, a traffic sign, a bicycle, and a piece of furniture such as a table or a chair. The class of each object indicates overall dimensions of the object (e.g., height and width) and the threat level of the object, where the threat level indicates a level of impact the object may have upon the vehicle 12 in the event of a collision. The threat level is based on an estimated mass of the object, where the estimated mass is determined based on the overall dimensions of the object. An object with greater mass poses a greater threat to the vehicle 12. The path planning and navigation module 60 may then assign a size sₖ, a range parameter rₖ and a force mass parameter mx to each object based on the class of the object. Specifically, the size sₖ is assigned based on the overall dimensions, the range parameter rₖ is assigned based on the threat level, where a higher threat level increases the range parameter rₖ, and the force mass parameter mₖ is assigned based on the estimated mass of the object. If the size sₖ of the object is less than the distance d between the vehicle 12 and the object, and if the distance d is less than the range parameter rₖ, then the path planning and navigation module 60 solves for the repulsive field force from the object in Equation 18 and an angle of the repulsive field force in Equation 19 as:

$${P}_{R}^{k} = {m}_{k} * \sqrt{{\vert x - {x}_{k} \vert}^{2} + {\vert y - {y}_{k} \vert}^{2}} \qquad Equation 18$$

$${θ}_{R}^{k} = {tan}^{- 1} ( \frac{{y}_{k} - y}{{x}_{k} - x} ) \qquad Equation 19$$

where P_{R}^{k} represents the repulsive field force from the object and θ_{R} represents the angle of the repulsive field force.

The path planning and navigation module 60 determines the overall field force from the current location of the vehicle 12 based on the attractive field force P_{A}, the angle of the attractive field force θ_{A}, the repulsive field force from the object P_{R}^{k}, and the angle of the repulsive field force θ_{R}^{k} and is expressed in Equation 20 as:

$$P = ( {P}_{A} , {θ}_{A} ) + {\sum }_{k = 1}^{n} ( {P}_{R}^{k} , {θ}_{R}^{k} ) \qquad Equation 20$$

where P represents the overall field force.

Referring generally to the figures, the disclosed object detection system provides various technical effects and benefits. Specifically, the object detection system provides an approach for calibrating the raw camera depth of a target object, which is calculated using the image data captured by the non-stereo camera system, based on a real depth of the target object determined by the UWB sensor system, which results in reduced complexity and computational requirements when compared to an approach that utilizes perception data collected by LiDAR sensors. The disclosed approach also consumes less power when compared to an approach that utilizes perception data collected by radar sensors. It is also to be appreciated that identifying the target object based on the rotated object detection algorithms that determine a rotated bounding box provides improved depth and angle estimation when compared to object detection algorithms that utilize a bounding box that is aligned with the horizontal axis of the image frame.

The controllers may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the controllers may be microprocessor-based such as a computer having a at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An object detection system for a vehicle that estimates a location of a target object located in an environment surrounding the vehicle, the object detection system comprising:
an ultra-wide band (UWB) sensor network including three or more anchors mounted to the vehicle that are in wireless communication with a tag mounted to the target object, wherein each anchor sends and receives sensor signals that indicate real-time distances between each anchor and the tag;
a non-stereo camera system that captures image data representing the target object located in the environment surrounding the vehicle; and
one or more controllers in electronic communication with the UWB sensor network and the non-stereo camera system, wherein the one or more controllers includes one or more processors that execute instructions to:
estimate a camera-based location of the target object based on the image data, wherein the camera-based location is adjusted to account for a calibrated camera estimated depth determined during an initial calibration procedure;
estimate a UWB-based location of the target object by executing one or more range-based localization algorithms that analyze the sensor signals; and
fuse together the camera-based location of the target object and the UWB-based location of the target object by a Bayesian filter to estimate the location of the target object.

2. The object detection system of claim 1, wherein the Bayesian filter is a Kalman filter.

3. The object detection system of claim 2, wherein a process model of the Kalman filter predicts a plurality of state vectors of the vehicle.

4. The object detection system of claim 3, wherein a measurement model of the Kalman filter performs an update of the plurality of state vectors of the vehicle determined by the process model based on an observation vector.

5. The object detection system of claim 1, wherein the calibrated camera estimated depth represents a raw camera depth of the target object determined based on the image data captured by the non-stereo camera system that is calibrated based on a real depth of the target object.

6. The object detection system of claim 5, wherein the real depth of the target object is determined based on the sensor signals from the UWB sensor network.

7. The object detection system of claim 1, wherein the initial calibration procedure includes:
executing one or more rotated object detection algorithms that determine a rotated bounding box that identifies the target object located within a corresponding image frame of the image data.

8. The object detection system of claim 7, wherein the rotated object detection algorithm is the you only look once (YOLO) Darknet-53 algorithm with a recurrent neural network (RNN).

9. The object detection system of claim 7, wherein the initial calibration procedure includes:
determining a plurality of location parameters of the rotated bounding box, wherein the location parameters of the rotated bounding box include an x-axis location coordinate, a y-axis pixel coordinate, a width of the rotated bounding box, a height of the rotated bounding box, and an angular orientation of the rotated bounding box relative to the horizontal axis of the corresponding image frame.

10. The object detection system of claim 9, wherein the initial calibration procedure includes:
determining a raw camera depth based on:
$${d}_{cam} = \frac{{f}_{cam} * {h}_{real}}{{h}_{b}}$$
wherein d_{cam} represent the raw camera depth, h_{b} represents the height of the rotated bounding box h_{b}, f_{cam} represents a focal length of a camera that is part of the non-stereo camera system, and dᵣₑₐₗ represents a real depth of the target object determined based on the sensor signals received from the three or more anchors.

11. The object detection system of claim 10, wherein a relationship between the raw camera depth and a center of the corresponding image frame is expressed by an equation of a line:
$$y = β x + γ$$
where β represents a gradient of the line and γ represents a y-axis intercept point of the line.

12. The object detection system of claim 11, wherein the initial calibration procedure includes:
solving a linear regression model representing a relationship between the raw camera depth, the real depth of the target object, an error that is introduced by image distortion of the camera, the gradient, the y-axis intercept point, and a center of the corresponding image frame, and wherein the linear regression model is expressed as:
$$e = {d}_{cam} - {d}_{real} = β * {d}_{cen} + γ$$
wherein e represents the error and d_{cen} represents the center of the corresponding image frame.

13. The object detection system of claim 12, wherein the initial calibration procedure includes:
solving for the calibrated camera estimated depth based on a difference between the raw camera depth and the error that is expressed as:
$${D}_{cali} = {d}_{cam} - e$$
wherein D_{cali} represents the calibrated camera estimated depth.

14. The object detection system of claim 1, wherein the calibrated camera estimated depth accounts for an error introduced by lens distortion of a camera that is part of the non-stereo camera system, and wherein the error is linearly related to a center of a corresponding image frame of the image data.

15. The object detection system of claim 1, wherein the one or more processors of the one or more controllers execute instructions to:
build a vector map based on an attractive field force between the vehicle and a target location, repulsive field forces between the vehicle and the target object and the vehicle and one or more remaining objects located in the environment, and an overall field force at a current location of the vehicle.

16. The object detection system of claim 15, wherein the target location represents a destination location of the vehicle.

17. An object detection system for a vehicle that estimates a location of a target object located in an environment surrounding the vehicle, the object detection system comprising:
an ultra-wide band (UWB) sensor network including three or more anchors mounted to the vehicle that are in wireless communication with a tag mounted to the target object, wherein each anchor sends and receives sensor signals that indicate real-time distances between each anchor and the tag;
a non-stereo camera system that includes a camera that captures image data representing the target object located in the environment surrounding the vehicle; and
one or more controllers in electronic communication with the UWB sensor network and the non-stereo camera system, wherein the one or more controllers includes one or more processors that execute instructions to:
estimate a camera-based location of the target object based on the image data, wherein the camera-based location is adjusted to account for a calibrated camera estimated depth determined during an initial calibration procedure, wherein the calibrated camera estimated depth accounts for an error introduced by lens distortion of the camera and the error is linearly related to a center of a corresponding image frame of the image data;
estimate a UWB-based location of the target object by executing one or more range-based localization algorithms that analyze the sensor signals; and
fuse together the camera-based location of the target object and the UWB-based location of the target object by a Kalman filter to estimate the location of the target object.

18. The object detection system of claim 17, wherein the initial calibration procedure includes:
executing one or more rotated object detection algorithms that determine a rotated bounding box that defines the target object located within a corresponding image frame of the image data.

19. The object detection system of claim 18, wherein the rotated object detection algorithm is the you only look once (YOLO) Darknet-53 algorithm with a recurrent neural network (RNN).

20. An object detection system for a vehicle that estimates a location of a target object located in an environment surrounding the vehicle, the object detection system comprising:
an ultra-wide band (UWB) sensor network including three or more anchors mounted to the vehicle that are in wireless communication with a tag mounted to the target object, wherein each anchor sends and receives sensor signals that indicate real-time distances between each anchor and the tag;
a non-stereo camera system that includes a camera that captures image data representing the target object located in the environment surrounding the vehicle; and
one or more controllers in electronic communication with the UWB sensor network and the non-stereo camera system, wherein the one or more controllers includes one or more processors that execute instructions to:
estimate a camera-based location of the target object based on the image data, wherein the camera-based location is adjusted to account for a calibrated camera estimated depth determined during an initial calibration procedure, wherein the calibrated camera estimated depth accounts for an error introduced by lens distortion of the camera and the error is linearly related to a center of a corresponding image frame of the image data, and wherein the initial calibration procedure includes executing one or more rotated object detection algorithms that determine a rotated bounding box that defines the target object located within a corresponding image frame of the image data;
estimate a UWB-based location of the target object by executing one or more range-based localization algorithms that analyze the sensor signals; and
fuse together the camera-based location of the target object and the UWB-based location of the target object by a Kalman filter to estimate the location of the target object.
